(19) United States
(12) Patent Application Publication
(10) Pub. No.: US 2010/0033788 A1
(43) Pub. Date: Feb. 11, 2010

(54) MICROMIRROR AND FABRICATION METHOD FOR PRODUCING MICROMIRROR

(75) Inventors: Huikai Xie, Gainesville, FL (US); Sarah Maley, Beavercreek, OH (US); Paul McManamon, Dayton, OH (US); Thomas Nelson, Dayton, OH (US); Lei Wu, Gainesville, FL (US); Andrea Pais, Gainesville, FL (US); Kemiao Jia, Gainesville, FL (US)

Correspondence Address: SALIWANCHIK LLOYD & SALIWANCHIK;A PROFESSIONAL ASSOCIATION, PO Box 142950, GAINESVILLE, FL, 32614, US

(73) Assignee: University of Florida Research Foundation, Inc., Gainesville, FL (US)

(21) Appl. No.: 12/534,514

(22) Filed: Aug. 3, 2009

Related U.S. Application Data
(60) Provisional application No. 61/085,725, filed on Aug. 1, 2008.

(51) Int. Cl. G02B 26/10; G02B 26/08; H01L 21/50

(52) U.S. Cl. 359/198.1; 359/221.2; 438/106; 257/E21.499

(57) ABSTRACT

A high-fill-factor and large-aperture tip-tilt micromirror array is disclosed. Electrothermal actuation can be used to obtain a large scan range, and the actuation engine can be hidden underneath the mirror plate for high fill factor. In one embodiment, inverted-series-connected (ISC) bimorph actuators can be used to achieve tilt and piston scanning. Embodiments can be used to implement optical phased array technology for steering active and passive electro-optical systems based on MEMS mirrors.

### CROSS-REFERENCE TO RELATED APPLICATION

The present application claims the benefit of U.S. Provisional Application Ser. No. 61/085,752, filed Aug. 1, 2008, which is hereby incorporated by reference herein in its entirety, including any figures, tables, or drawings.

The subject invention was made with government support under a research project supported by U.S. Air Force Grant No. FA9550-08-0292.

### BACKGROUND OF INVENTION

Laser beam steering is the precise and controllable delivery of laser beams or other guided modes to a desired location. Image sensing, laser displays, and optical switches are examples of applications that utilize laser beam steering. Currently, laser beam steering is required in a broad variety of applications including optical displays, communications, biomedical imaging, space, battlefields, surveillances, and homeland security.

To accomplish laser beam steering, liquid crystals may be used. However, laser beam steering devices based on liquid crystals currently are expensive, have small apertures and dispersion problems, and steer over relatively narrow angles [1][2].

A micromirror is an optical semiconductor device that has a movable mirror plate. Micromirrors can also be used for laser beam steering applications. They may scan angularly in one dimension (1D) or 2D, and/or scan linearly, for instance, for phase control.

For endoscopic biomedical imaging, beam scanning devices with small size are crucial. However, existing laser beam scanning devices have small fill factors due to the large area needed for the actuation mechanisms. Small fill factors greatly increase the overall device size. This becomes a serious problem for intravascular imaging.

For air surveillance, large optical apertures are required. However, large mirrors tend to have very slow scanning speeds. In order to increase scanning speed, an optical aperture usually is partitioned into an array of a much smaller aperture, such as an optical phased array (OPA). In this case, the fill factor of the mirror array is a very important parameter since high-power lasers are usually used. If the fill factor is small, a large amount of power will be wasted. In addition, this ‘wasted’ power may hit on the actuators of the mirrors, which can damage the mirrors.

Existing micromirrors with high fill factors are currently made of thin-film microstructures. Consequently, their optical aperture sizes are small. Furthermore, thin-film Micro-Electro-Mechanical System (MEMS) mirrors tend to curl.

A variety of mechanisms that can be used for actuation in MEMS designs include electromagnetic, piezoelectric, electrostatic, and electrothermal actuation. Electromagnetic actuation requires external magnets, which complicates device packaging. Piezoelectric actuation typically achieves displacements on the order of a few microns. Electrostatically-actuated micromirrors can be difficult to scale up. In contrast, electrothermal actuation can generate large angular displacements.

Most micromirror designs are based on electrostatic actuation, which results in high driving voltages and small actuation ranges. The mirror portion of a micromirror is usually made from a reflective material such as aluminum. In one mirror actuation approach, each mirror is mounted on a yoke that is connected to two support posts by compliant torsion hinges. In this type of hinge, the axle is fixed at both ends and twists in the middle. Two pairs of electrodes control the position of the mirror by electrostatic attraction. Each pair has one electrode on each side of the hinge, with one of the pairs positioned to act on the yoke and the other acting directly on the mirror. Equal bias voltages are applied to both sides simultaneously to hold the mirror in its current position. A voltage difference applied to the two sides will generate angular scanning.

The electrothermal actuation approach for micromirror actuation has been demonstrated with rotation angles ranging from 30° to over 100° with mirror apertures of 1 mm to 3 mm. [3]-[8]. However, most of these micromirrors rotate about a hinge at the end of the mirror plate, so the optical center of rotation shifts during the mirror tilting. This center shift generates an optical phase delay and a lateral shift of the optical beam on the target. Furthermore, these mirrors have very small fill factors.

### BRIEF SUMMARY

Embodiments of the present invention relate to a method and apparatus for high-fill-factor micromirror beam steering. Embodiments also pertain to a method of fabricating high-fill-factor micromirrors and micromirror arrays. Embodiments of the present invention can provide high-fill-factor micromirrors by hiding at least a portion of, and preferably the entire actuating engine underneath the mirror plate of each micromirror. In a further embodiment, the hidden actuators of the actuating engine can be located close to the center of the mirror plate such that a small displacement of the actuators can generate a large scanning motion of the mirror plate. Large aperture sizes can be implemented through making the mirror plate using single-crystal silicon. According to an embodiment, the actuators and the mirror plate can be made on a single substrate.

A micromirror according to an embodiment can include a micromirror plate formed of single-crystal silicon; a plurality of electrothermal actuators provided under the micromirror plate; and a pillar structure, wherein the pillar structure interconnects the plurality of electrothermal actuators to the micromirror plate.

In an embodiment, a method of fabricating a micromirror can include preparing a silicon-on-insulator (SOI) substrate: fabricating electrothermal actuators on a front side of the SOI substrate; and fabricating a micromirror plate on a back side of the SOI substrate, wherein an inner silicon region of the SOI substrate is removed except for a region providing a pillar structure interconnecting the plurality of electrothermal actuators and the micromirror plate. The front side of the SOI substrate can be bonded to an anchor substrate for mechanical support.

### BRIEF DESCRIPTION OF DRAWINGS

FIG. 1A shows an inverted-series-connected (ISC) S-shaped vertical actuator design according to an embodiment of the present invention.

FIG. 1B shows a perspective view of an ISC actuator.

FIG. 1C shows a bimorph actuator that can be used in accordance with an embodiment of the invention.

FIG. 1D shows the perspective view of an embodiment incorporating the actuator shown in FIG. 1C.

FIG. 2 shows a micromirror according to an embodiment of the present invention.

FIGS. 3A-3J show a cross-sectional view of the fabrication process flow according to an embodiment of the present invention, where, for simplicity, the heater in the oxide opening is not shown in the steps of the process.

FIG. 4 shows a high-fill-factor micromirror array with hidden actuators.

FIGS. 5A-5B show frame-supported high-fill-factor micromirror embodiments, where FIG. 5A shows a center supported micromirror design, and FIG. 5B shows an edge supported micromirror design.

FIGS. 6A-6B show anchor-supported high-fill-factor micromirror embodiments, where FIG. 6A shows a symmetric micromirror, and FIG. 6B shows a single-sided micromirror.

FIG. 7 shows geometrical dimensions of an ISC actuator.

FIGS. 8A-8E show a layout of the entire mask set and various mirror arrays according to an embodiment of the present invention.

### DETAILED DISCLOSURE

Embodiments of the present invention relate to a method and apparatus for high-fill-factor micromirror beam steering. Embodiments also pertain to a method of fabricating high-fill-factor micromirrors and micromirror array. According to an embodiment, the micromirror can have multi-degree-of-freedom motion control. In a farther embodiment, a large scanning range can be implemented. Advantageously, embodiments of the present invention can provide both a large scanning range and high fill factors. In one embodiment, process integration can be accomplished to fabricate the subject micromirrors without assembling multiple separate components.

According to an embodiment, at least a portion of, and preferably the entirety of the actuators for a micromirror can be located underneath the mirror plate. Accordingly, embodiments can provide high fill factors. In one embodiment, fill factors can be greater than 90%. In a specific embodiment, the fill factor can be limited by only the spacing between adjacent mirror plates because the actuators can be positioned completely below the mirror plates.

By making a mirror plate from single-crystal silicon (SCS), the mirror plate can be made flat and large. Accordingly, embodiments are capable of providing a large aperture size. The mirror plate can be coated with a metal, such as aluminum or gold, or can be coated with a multi-layer thin-film stack, such as a highly reflective multi-layer thin film stack.

By locating actuators close to the center of the mirror plate and below the mirror plate, a small displacement of the actuators can generate large scanning of the mirror plate. Accordingly, a low driving voltage can be used to provide a large angular scan range.

The subject micromirrors can be fabricated using an integrated process. For example, in one embodiment, the actuators and the mirror plate can be made on a single substrate. Then wafer-level or flip-chip bonding can be used to bond the substrate having the actuators and the mirror plate to a support substrate to provide mechanical support. In one embodiment, the support substrate can also provide electrical connections. The electrical connections may be provided by through-silicon vias. Advantageously, the integrated process of certain embodiments of the present invention can produce a high yield of devices.

Embodiments of the present invention can be used to provide a variety of high-fill-factor (HFF) products, including but not limited to HFF scanning mirrors; HFF vertical scanning mirrors; HFF microlenses; HFF micromirror arrays; HFF microlens arrays; HFF optical phased arrays; HFF micromirror-based optical imaging probes; and HFF microlens-based endoscopic imaging probes.

Large-aperture, tip-tilt-piston micromirrors can be difficult to make. Large-aperture micromirrors with large rotation angles are desired for certain laser beam steering applications. However, thin-film MEMS mirrors are generally not suitable for such applications because of their curling and small sizes. Advantageously, single-crystal silicon (SCS) based micromirrors can be employed in large-aperture micromirrors for flatness and robustness.

To increase scanning speed where a large optical aperture is needed, the optical aperture usually is partitioned into an array of much smaller apertures. In one embodiment, this array can be an optical phased array (OPA). An OPA is not a simple homogeneous micromirror array. Rather, in an OPA, each micromirror generates a phase shift such that the phase differences of the light from all the micromirrors will be only zero or multiple 2π (modulo 2π). In other words, each micromirror can simultaneously generate independently-controllable rotational and piston motion.

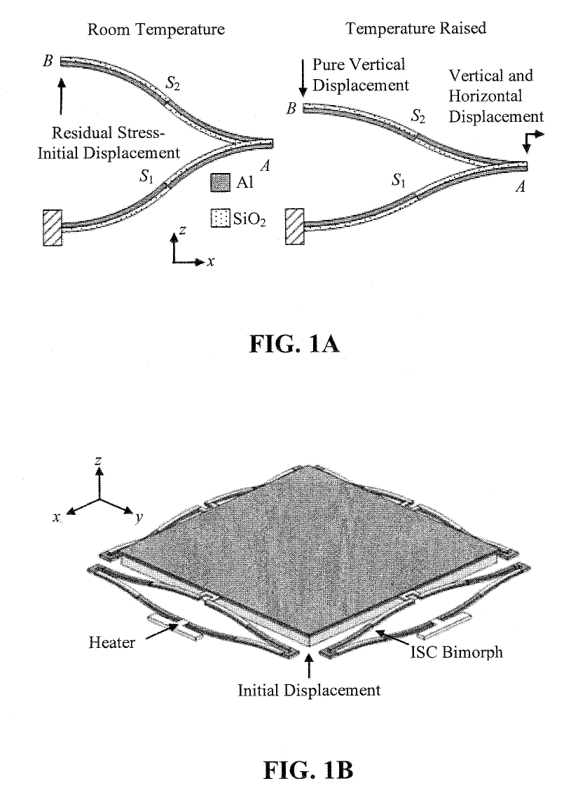

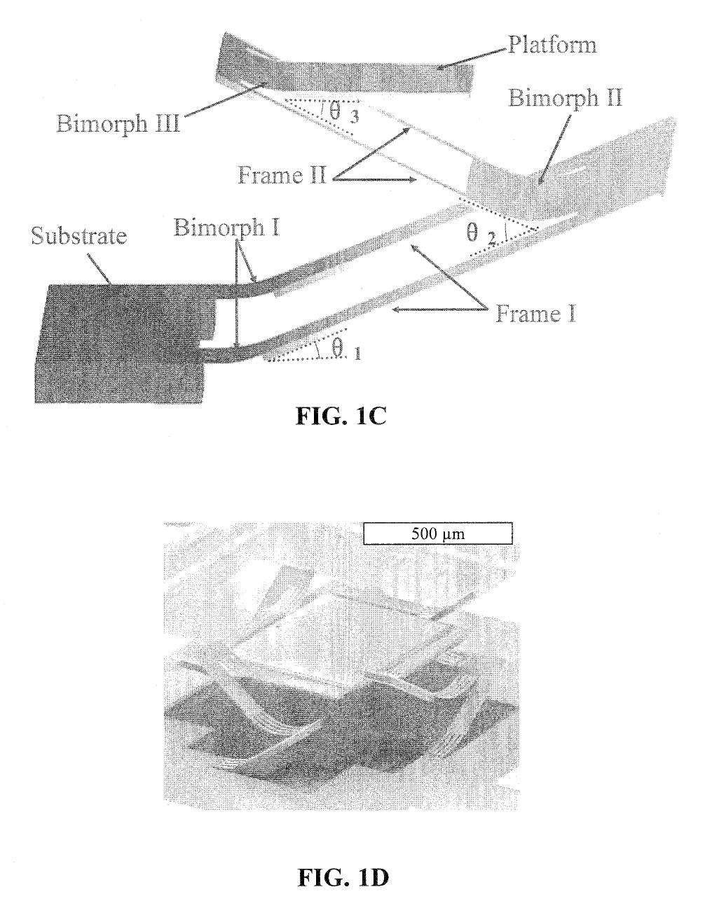

Embodiments of the present invention can provide a high-fill-factor and large-aperture tip-tilt-piston micromirror array. According to an embodiment, the high fill factor can be accomplished by locating the actuation engine at least partially, and preferably entirely, underneath the mirror plate. Electrothermal actuation can be used to obtain a large scan range. The electrothermal actuation can be accomplished through bi-layer, i.e., bimorph or multi-layer structures with materials having different coefficients of thermal expansion (CTEs). In one embodiment, the actuators can be inverted-series-connected (ISC) bimorph actuators. The ISC bimorph actuators can be used to achieve tip, tilt and piston scanning. Referring to FIG. 1A, an ISC bimorph actuator includes two S-shaped bimorph sections attached end-to-end. An individual S-shape section can have two bimorph sections attached in series where one section has a high-CTE top metal layer and a low-CTE bottom dielectric layer, and the adjacent section has opposite layer composition. The high-CTE metal can be, for example, aluminum (Al). The low-CTE dielectric can be, for example, silicon dioxide (SiO₂). This alternating construction of the material layers allows each bimorph section to have equal and opposite curvature upon actuation so that the beam deforms to an S-shape and has zero tangential angle at the end. Each S-shape section has a lateral displacement when actuated. Point A in FIG. 1A moves in both x and z directions. However, the lateral shifts of S₁ and S₂ cancel each other, resulting in a pure z-displacement at point B. FIG. 1B shows an embodiment using ISC bimorph actuators for multi-axis actuation, which can rotate along the x and y axes and generate piston motion in the z-axis direction.

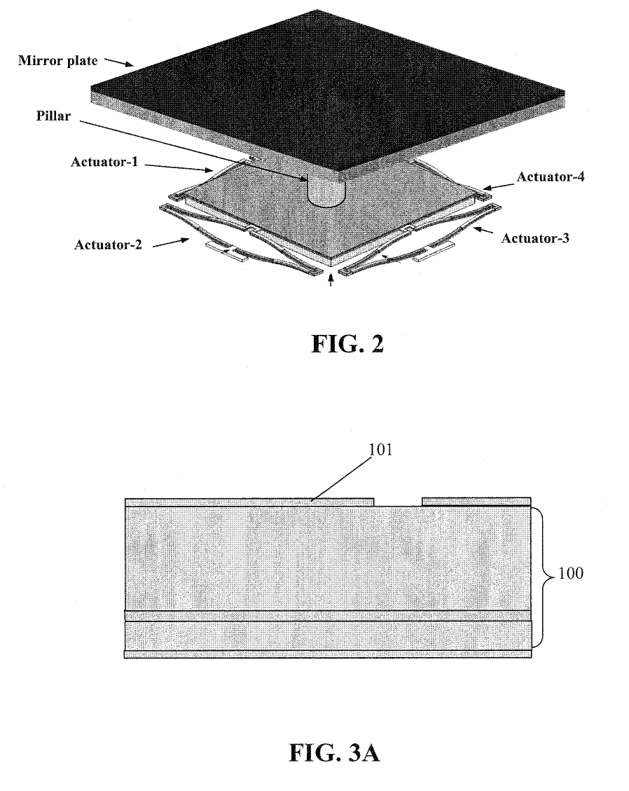

To obtain large rotation angles, the structure shown in FIG. 1B can be used as an actuator with a mirror plate sitting on top. FIG. 2 shows such an embodiment. In this configuration, the lower plate can be very small and the ISC beams can be short. Thus, large rotation angles can be achieved with small ISC beam deflections.

For one dimensional (1-D) rotation and piston motion, all four actuators can be first provided with equal currents. Then, in one example, for pure rotation, the current of Actuator-2 is increased while the current of Actuator-4 is decreased by the same amount. For pure piston, the currents of all four actuators are decreased or increased by the same amount.

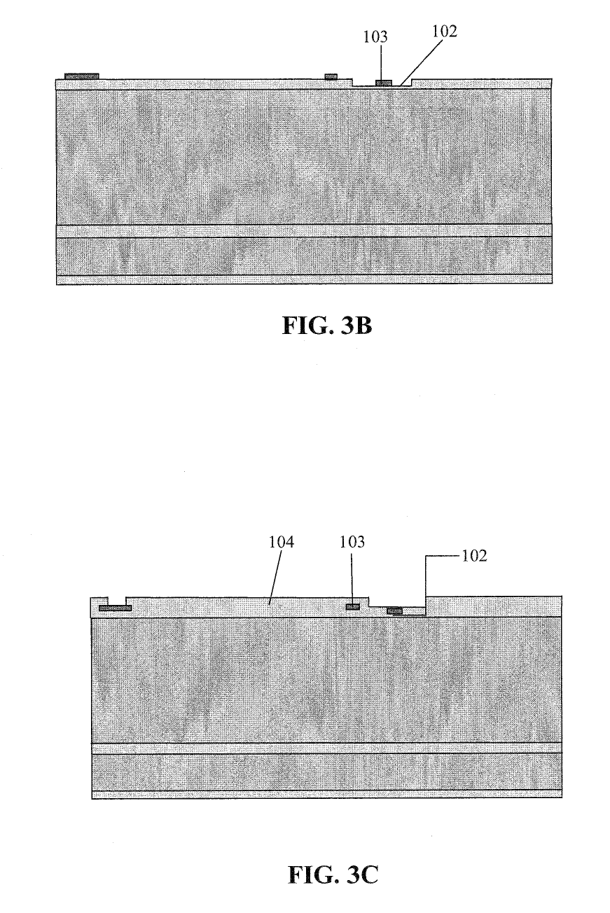

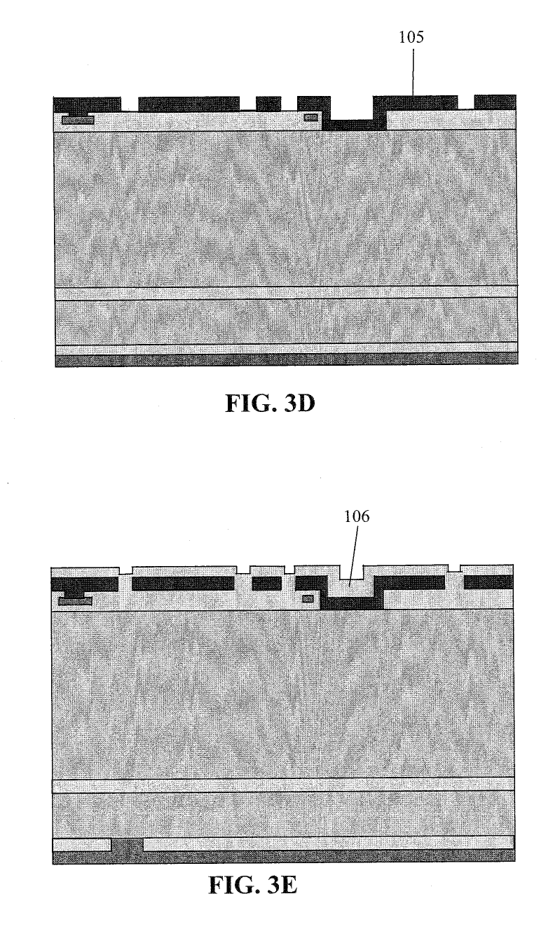

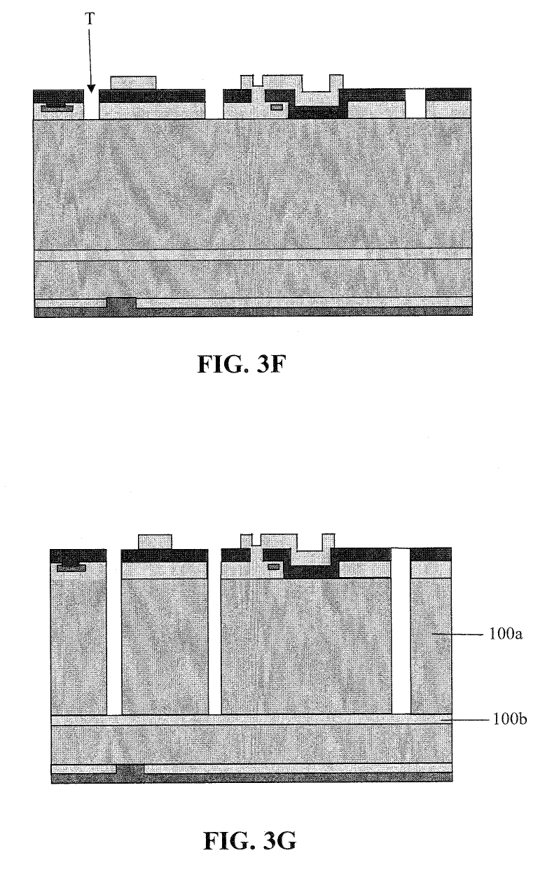

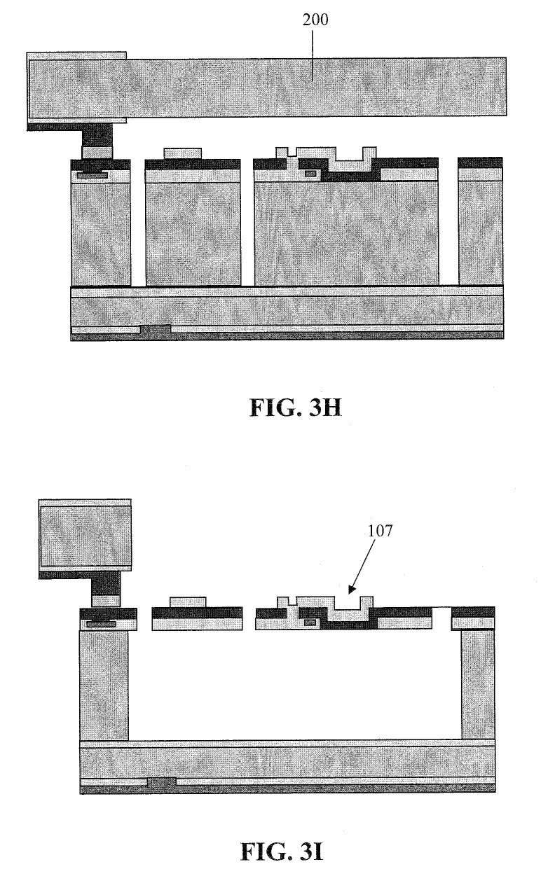

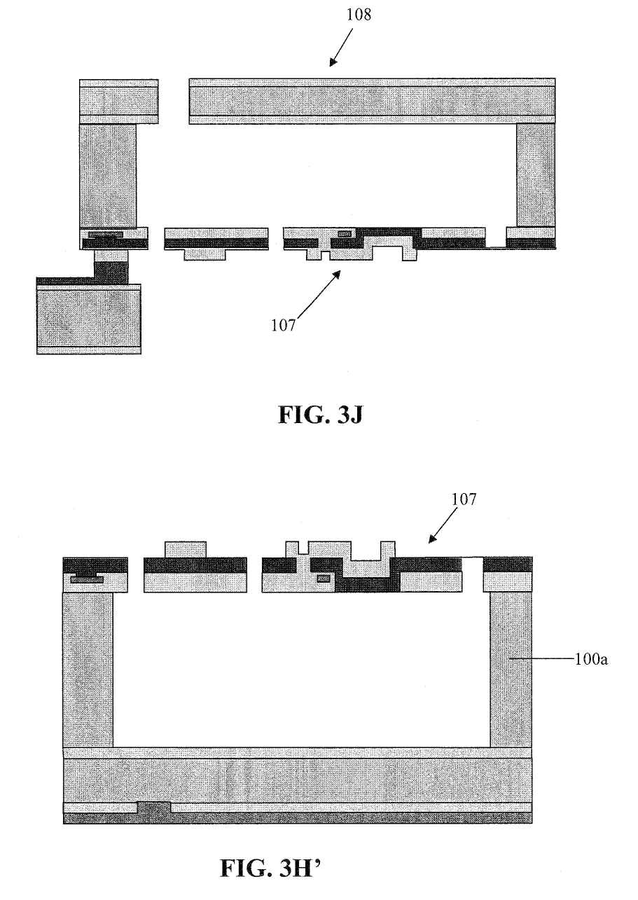

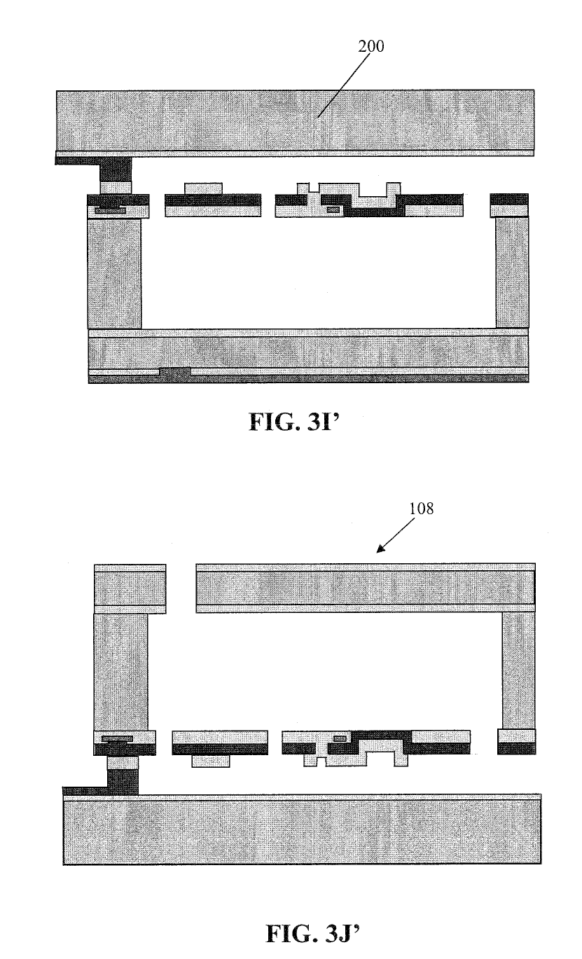

In one embodiment, a micromachining process based on a silicon-on-insulator (SOI) wafer can be used to fabricate the device without assembling. The process flow according to an embodiment is shown in FIGS. 3A-3J.

Referring to FIG. 3A, the process starts with SOI wafers. First, the original oxide on the front side of an SOI wafer 100 is removed. Then, 1 μm PEVCD SiO₂ is deposited on the front side. In certain embodiments, dielectric coating can be performed if high-reflectance dielectric mirrors are desired. In a specific embodiment, a multi-layer thin film stack can be used. There are two types of bimorph beams that can be fabricated: one type of bimorph has oxide on top and Aluminum (Al) on bottom; while the other bimorph type is opposite with Al on top and oxide on bottom. The temperature change for the actuator can be provided by an integrated heater. In one embodiment, the heater can be made of Platinum (Pt).

As shown in FIG. 3A, the front side oxide 101 is patterned and etched to define the areas where the Al/oxide bimorphs (i.e., bimorphs with oxide on bottom) will be formed. Next, referring to FIG. 3B, a 0.1 μm-thick oxide layer 102 is deposited, followed by a 0.1 μm-thick Pt sputtering; and the Pt layer 103 is patterned by lift-off to form the heater(s). Next, as shown in FIG. 3C, after a 0.1 μm-thick PECVD SiO₂ layer 104 is deposited as the dielectric layer between Pt (103) and Al (to be formed), contact vias are patterned and etched. Next, as shown in FIG. 3D, an Al deposition (1 μm thick) followed by lift-off patterning forms the aluminum layer 105 of the bimorph beams. Next, as shown in FIG. 3E, a PECVD SiO₂ layer 106 (1 μm thick) is deposited on the front side; and a two-side alignment can be performed to form the mirror trenches (not shown) on the back side. Next, as shown in FIG. 3F, the front oxide layers (104 and 106) are patterned to form Al/oxide bimorphs (i.e., bimorphs with oxide on top) and to expose silicon trench areas T. Next, as shown in FIG. 3G, an anisotropic ICP silicon etch can be performed and stopped at the buried oxide layer 100b of the SOT wafer 100 to form trenches in the silicon layer 100a of the SOI wafer 100. Note that the layer thickness values provided here are just for a reference. They can vary in a large range.

At this point, the process can be continued at either wafer level or die level. The difference between the two cases is that the wafer-level processing uses wafer-to-wafer bonding while the die-level processing will add a dicing step and use flip-chip bonding. The following steps are the same for both cases. For either case, there are a variety of options. Two options in accordance with embodiments of the invention are illustrated: one is shown by FIGS. 3H-3J and the other by FIGS. 3H′-3J′.

For the former option, as shown in FIG. 3H, a bonding (either wafer-to-wafer or flip-chip) is performed. Next, as shown in FIG. 3I, an anisotropic silicon etch is performed to etch through the carrier substrate 200 followed by an isotropic silicon etch to undercut the silicon underneath the oxide/Al or Al/oxide bimorphs 107. In one embodiment, the carrier substrate 200 can be pre-fabricated with an oxide pattern (not shown) on one side and copper wires with electroplated copper/indium spacers (not shown) on the other side. The copper portion can be, for example, 15 μm thick and the indium portion can be, for example, 6 μm thick. The indium layer functions as the bonding material. Bonding materials other than indium can be used. For example, conductive epoxy, conductive polymers, lead (Pb), Pb alloys, tin (Sn) and Sn alloys may be used. Finally, as shown in FIG. 3J, the bonded assembly is flipped over and a silicon etch (anisotropic or isotropic) followed by a dry oxide etch can be used to release the mirror 108.

For the latter option (FIG. 3H′-3J′), as shown in FIG. 3H′, an isotropic silicon etch can be used to undercut the silicon 100a underneath the oxide/Al or Al/oxide bimorphs 107. Next, as shown in FIG. 3I′, a bonding (either wafer-to-wafer or flip-chip) can be performed. This can be accomplished using a carrier substrate 200 as described above. Finally, as shown in FIG. 3J′, the bonded assembly is flipped over and a silicon etch (anisotropic or isotropic) followed by a dry oxide etch can be used to release the mirror 108.

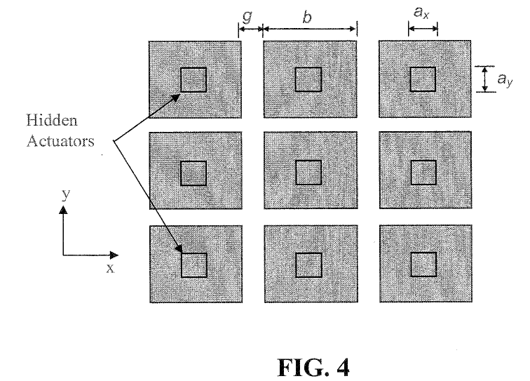

According to embodiments, to increase the fill factor, the actuators are located, or hidden, at least partially and preferably entirely, underneath the movable mirror plates, as shown in FIG. 4. The fill factor is given by

$$f = \frac{b}{g + b} ,$$

where g is the gap between adjacent mirror plates, and b is the active mirror pixel size. For example, if g=0.1 mm and b=1 mm, then the fill factor will be 91%. If g=0.1 mm and b=5 mm, then the fill factor can be as high as 98%. According to embodiments, b can range from 1 mm to 10 mm and g can range from 10 μm to 200 μm.

Meanwhile, the size of the actuators is much smaller than the mirror plates along the rotation direction(s) such that the mirror plates have enough room to rotate. For instance, if the mirror plates rotate about y axis, then aₓ should be much smaller than b. If the mirror plates rotate about both x and y axis, then both aₓ and a_{y} must be smaller than b. For instance, an HFF mirror array can be designed with hidden actuator size of (aₓ and a_{y}) 800 μm and mirror size (b) of 2.45 mm, such that

$$\frac{{a}_{x}}{b} and \frac{{a}_{y}}{b}$$

are less than ⅓.

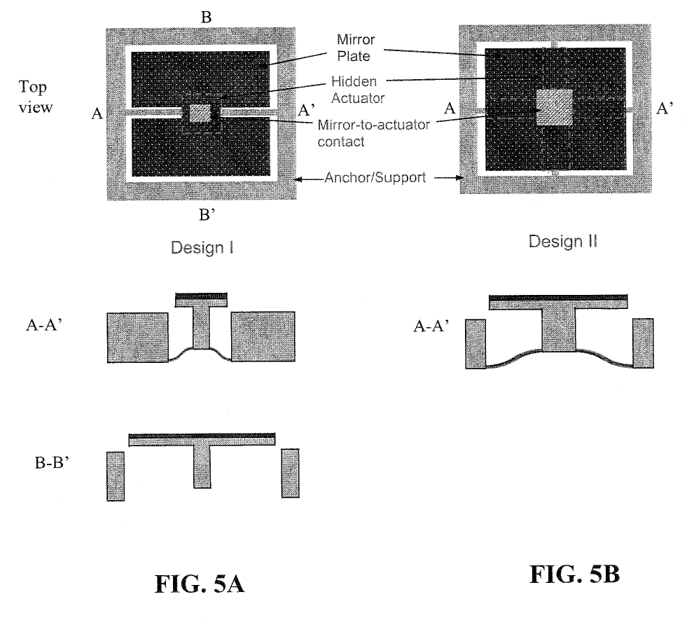

The actuators underneath the mirror plates can be anchored on a substrate. FIGS. 5A and 5B show two embodiments with rigid frames as the mechanical support. The dashed squares outline the actuator regions, and the shaded squares are the mirror-to-actuator contact areas. For the embodiment shown in FIG. 5A, the actuator is much smaller than the mirror plate and is located in the center. In order to support the actuator, the mirror is cut through on both sides allowing the actuator to anchor on two rigid silicon beams. For the embodiment shown in FIG. 5B, the actuators are distributed under the mirror plate. The actuators' distal ends reach to the edges of the mirror plate and no mirror cut is necessary.

Comparing these two embodiments, the embodiment of FIG. 5A can have larger mirror aperture size but it can only perform one-dimensional scanning and there is a cut on the mirror surface. The embodiment shown in FIG. 5B provides two-dimensional scanning and has no cut on the mirror surface, but the mirror aperture size is limited (typically <1 mm).

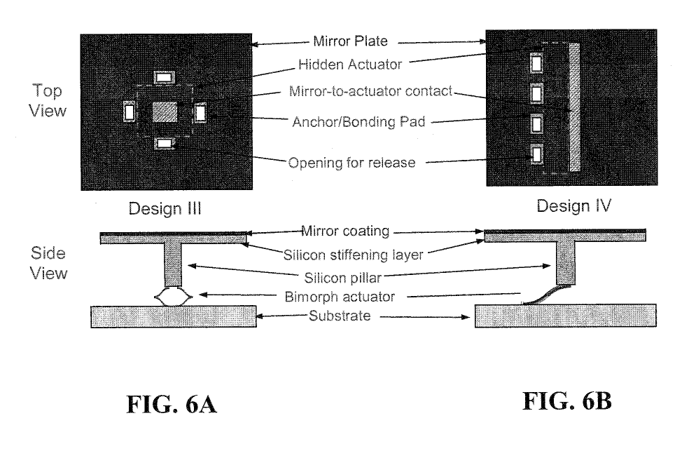

Using frames as support (as the embodiments shown in FIGS. 5A-5B) significantly limits the maximum achievable fill factor (typically less than 85%). In order to obtain even higher fill factors, actuators can be anchored directly under the mirror plate, as illustrated in FIGS. 6A-6B. The white rectangles are small openings on the mirror surface for the purpose of final device release. The openings' sizes should be slightly greater than the anchors, which are about 100 μm. For apertures of 2 mm or above, the fill factor can easily reach 95%.

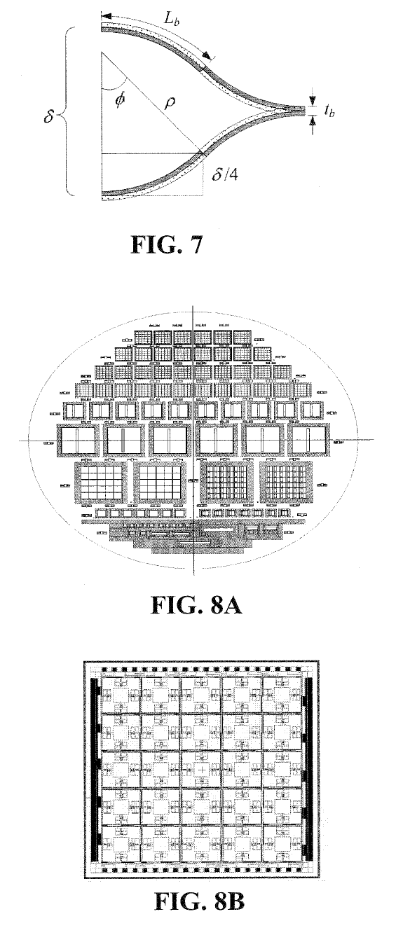

The geometric parameters of an ISC actuator are defined in FIG. 7, where δ is the vertical elevation, L_{b} is the length of each bimorph section, t_{b} is the bimorph beam thickness, and ρ is the radius of curvature of the bimorphs. The vertical displacement at the tip of the top bimorph is given by

$$Δ δ \approx \frac{2 {β}_{ρ} {L}_{b}^{2}}{{t}_{b}} Δ {α}_{T} Δ T ,$$

where a_{T} is the difference of the CTEs of the material layers, and β_{ρ} is a parameter called the curvature coefficient. β_{ρ} is a unit-less parameter that varies from 0 to 1.5 and depends on the relative layer thicknesses and elastic moduli. With L_{b}=100 μm and t_{b}=2 μm, the maximum tip displacement and tilt angle are about 50 μm and +/−15° at a 100° C. temperature change.

For optical phased arrays, the required vertical displacement is in the range of 10 μm, and the rotation angle is in the range of +/−15°. Accordingly, in one embodiment, the following parameters can be used: Length: L_{b}=90 μm; Bimorph thickness: t_{b}=2 μm; Bimorph materials: Al and SiO₂; and Heater material: Platinum.

An S-shaped actuator is half of an ISC actuator. The advantages of using single S-shaped actuators include the simplicity and larger scan range. The same geometric parameters for ISC actuators can be used for S-shaped actuators.

Five mirror embodiments with the mirror sizes ranging from 1 mm to 10 mm and five mirror arrays with the aperture sizes ranging from 5 mm to 12.5 mm have been implemented. A photomask set with all the embodiments has been made.

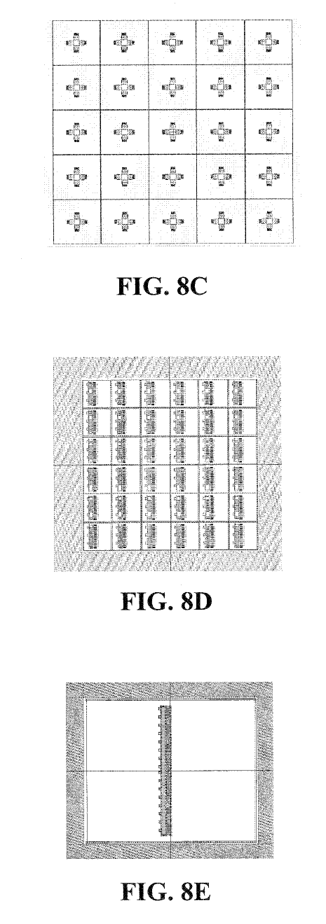

FIGS. 8A-8E show wafer layout and photomask designs according to the example implementations. The layout was drawn in Cadence and the photomasks were made at Photo Sciences. The photomasks are 5″×5″ for 4″ wafers. The entire layout is shown in FIG. 8A. It includes several different designs: (1) Arrays of 5×5 1 mm micromirrors based on Design II shown in FIG. 5B with ISC actuators (FIG. 8B); (2) Arrays of 5×5 1 mm micromirrors based on Design III shown in FIG. 6A with ISC actuators; (3) Arrays of 5×5 2.5 mm micromirrors based on Design III with ISC actuators (FIG. 8C); (4) Arrays of 6×6 2.5 mm micromirrors based on Design IV shown in FIG. 6B with S-shaped actuators (FIG. 8D); (5) A 1D array of 5 mm micromirrors based on Design IV with S-shaped actuators; (6) A 1D array of 10 mm micromirrors based on Design IV with S-shaped actuators (FIG. 8E showing one of the 10 mm micromirrors); and (7) Many test structures.

A device was fabricated using a 4 inch SOI wafer having 50 μm device thickness, 1.5 μm buried oxide thickness, and 400 μm handling layer thickness.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

### REFERENCES

[1] Paul F. McManamon, “Agile Non-mechanical Beam Steering,” Optics & Photonics News (OPN), Vol. 17, No. 3, pp. 20-25.
[2] P. F. McManamon et al. “Optical phased array technology,” Proceedings of the IEEE, 84 (2), February 1996, pp. 268-298.
[3] H. Xie, “Vertical Displacement Device,” U.S. Pat. No. 6,940,630, issued on Sep. 6, 2005.
[4] A. Jain, H. Qu, S. T. Todd, and H. Xie, “A Thermal Bimorph Micromirror with Large Bi-Directional and Vertical Actuation,” Sensors and Actuators A, Vol. 122, pp. 9-15, July 2005.
[5] A. Jain, and H. Xie, “An Electrothermal Microlens Scanner with Low-Voltage, Large-Vertical-Displacement Actuation,” IEEE Photonics Technology Letters, Vol. 17, pp. 1971-1973 (2005).
[6] S. T. Todd, A. Jain, H. Qu and H. Xie, “A multi-degree-of-freedom micromirror utilizing inverted-series-connected bimorph actuators,” Journal of Optics A, Vol. 8 (2006), pp. 352-359.
[7] L. Wu and H. Xie, “A Large Rotation Angle Electrothermal Micromirror with Integrated Platinum Heater,” Proceedings of the 2006 IEEE/LEOS International Conference on Optical MEMS and Their Applications, 21-24 Aug. 2006, Big Sky, Mont., USA.
[8] A. Jain, and H. Xie, “Half-Millimeter-Range Vertically Scanning Microlenses for Microscopic Focusing Applications,” Hilton Head 2006: Solid-State Sensors, Actuators and Microsystems Workshop, pp. 74-77, Hilton Head Island, S.C., June 2006.
[9] A. Jain, and H. Xie, “A Single-Crystal-Silicon Micromirror for Large Bi-directional 2-D Scanning Applications,” Sensors and Actuators A, vol. 130-131 (2006), pp. 454-460.

1. A micromirror structure, comprising:
at least one micromirror, wherein each micromirror comprises:
a mirror plate;
a pillar structure; and
at least one electrothermal actuator,
wherein the pillar structure interconnects the at least one electrothermal actuator to the mirror plate, wherein at least a portion of one or more of the at least one electrothermal actuator is positioned under the mirror plate.

2. The micromirror structure according to claim 1, wherein the at least one micromirror comprises a plurality of micromirrors forming an array of micromirrors.

3. The micromirror according to claim 1, wherein the one or more of the at least one electrothermal actuator is positioned entirely under the mirror plate.

4. The micromirror according to claim 3, wherein activation of the at least one electrothermal actuator causes the micromirror to scan angularly in one dimension.

5. The micromirror according to claim 3, wherein activation of the at least one electrothermal actuator causes the micromirror to scan angularly in two dimension.

6. The micromirror according to claim 3, wherein activation of the at least one electrothermal actuator causes the micromirror to scan linearly.

7. The micromirror according to claim 3, wherein at least one micromirror comprises a plurality of micromirrors forming an array of micromirrors.

8. The micromirror structure according to claim 3, wherein the mirror plate is formed of single-crystal silicon.

9. The micromirror structure according to claim 3, wherein the mirror plate is coated with a metal.

10. The micromirror structure according to claim 3, wherein the mirror plate is coated with a multi-layer thin-film stack.

11. The micromirror structure according to claim 3, wherein each of the at least one electrothermal actuator is positioned entirely under the mirror plate.

12. The micromirror structure according to claim 3, wherein each of the at least one electrothermal actuator comprises a plurality of layers, wherein at least two of the plurality of layer have different coefficients of thermal expansion.

13. The micromirror structure according to claim 3, wherein each of the at least one electrothermal actuator comprises an S-shaped inverted-series-connected bimorph actuator.

14. The micromirror structure according to claim 3, wherein each of the at least one electrothermal actuator comprises a dual inverted-series-connected bimorph actuator.

15. The micromirror structure according to claim 7, wherein the array is an optical phased array.

16. The micromirror structure according to claim 7, wherein the array has a fill factor of at least 90%.

17. The micromirror structure according to claim 7, wherein the array has a fill factor of at least 95%.

18. The micromirror structure according to claim 7, wherein each actuator spans less than ⅓ of the length of the mirror plate.

19. The micromirror structure according to claim 7, wherein the array has an aperture in the range 5 mm to 12.5 mm.

20. The micromirror structure according to claim 7, wherein each mirror plate has a length in the range 1 mm to 10 mm.

21. The micromirror structure according to claim 7, wherein each micromirror is independently controlled with respect to rotation and piston motion.

22. The micromirror structure according to claim 7, wherein adjacent mirror plates have a separation from each other in the range 10 μm to 200 μm.

23. A method of fabricating at least one micromirror, wherein each micromirror comprises:
a mirror plate;
a pillar structure;
at least one electrothermal actuator;
wherein the pillar structure interconnects the at least one electrothermal actuator to the mirror plate, wherein at least a portion of one or more of the at least one electrothermal actuator is positioned below the mirror plate, wherein the method comprises:
preparing a silicon-on-insulator substrate;
fabricating the at least one electrothermal actuator on a front side of the silicon-on-insulator substrate; and
fabricating the mirror plate on a back side of the silicon-on-insulator substrate, wherein at least a portion of an inner silicon region of the silicon-on-insulator substrate is removed to create the pillar structure.

24. The method according to claim 23, further comprising:
bonding the front side of the silicon-on-insulator substrate to a carrier substrate.

25. The method according to claim 24, wherein the bonding is wafer-level.

26. The method according to claim 24, wherein the bonding is flip-chip bonding.

27. The method according to claim 24, wherein the at least one electrothermal actuator is released before the bonding.

28. The method according to claim 24, wherein the at least one electrothermal actuator is released after the bonding.

29. The method according to claim 23, wherein fabricating the at least one electrothermal actuator is done via an anisotropic silicon etch and an isotropic silicon etch.

30. The method according to claim 29, wherein the silicon etch is stopped by a buried oxide layer of the silicon-on-insulator substrate.

31. The method according to claim 27, wherein the carrier substrate has a recess to protect the at least one electrothermal actuator during bonding.

32. The method according to claim 28, wherein the carrier substrate has a through hole that allows the release of the at least one electrothermal actuator after bonding.

33. The method according to claim 24, wherein the carrier substrate has at least one through-silicon via for direct surface mounting.
